(19) United States
(12) Patent Application Publication
(10) Pub. No.: US 2016/0279510 A1
(43) Pub. Date: Sep. 29, 2016

(54) VENUE-WIDE TOURNAMENT GAMING FOR MOBILE DEVICES

(71) Applicant: AMI Entertainment Network, LLC, Trevose, PA (US)

(72) Inventors: Augustus John RUSSO, Blue Bell, PA (US); William L. LAYNE, Harleysville, PA (US)

(21) Appl. No.: 15/078,629

(22) Filed: Mar. 23, 2016

Related U.S. Application Data
(60) Provisional application No. 62/137,755, filed on Mar. 24, 2015.

(51) Int. Cl. A63F 13/27; A63F 13/79; A63F 9/18

(52) U.S. Cl. CPC A63F 13/27; A63F 9/183; A63F 13/79

(57) ABSTRACT

A system and associated methods are provided for displaying aspects of one or more multiplayer games on one or more mobile devices. Players may interact with the games via mobile devices. The system may select views of games so that gameplay is only feasible for individuals physically located at the venue with a particular display device.

### CROSS-REFERENCE TO RELATED APPLICATIONS

The present application claims the benefit of U.S. Provisional Patent Application No. 62/137,755, filed on Mar. 24, 2015 and titled “Venue-Wide Tournament Gaming for Mobile Devices” the entire contents of which are incorporated herein by reference in their entirety.

### BACKGROUND OF THE INVENTION

Venues such as bars, restaurants, and casinos, often supplement their services by providing multimedia content for the enjoyment of patrons. Outputting content that is relevant to patrons of a venue may encourage patrons to remain at the venue for longer periods of time, thereby allowing the venue to increase per-patron revenue. Furthermore, presenting desirable content may attract new and repeat patrons to a venue.

Such content is typically output on display devices deployed at the venues, such as televisions, projectors, or computer monitors. Typically a content output device, such as a computer, set-top box, disc player, or media-streaming device, is communicatively coupled to the display device. The content output device receives and/or reads the content from a medium or network such as the Internet, a cable television network, a satellite, or an optical or mass storage medium.

Another method for increasing engagement in a venue is to provide games, particularly multiplayer games. Dedicated gaming machines, however, require space and capital investment. Furthermore, even if gaming machines are purchased, the limited number of available machines generally limits engagement.

As mobile devices, such as cellular phones, have increased in capability, they have become viable platforms for gaming. Each patron will generally be carrying at least one mobile device. Mobile device games, however, do not provide any engagement with the venue that may increase patron participation and revenue.

It would therefore be desirable to provide systems and methods to increase patron engagement in gaming at a venue that are not limited by the number of dedicated gaming systems at the venue, particularly by leveraging mobile devices.

### BRIEF SUMMARY OF THE INVENTION

Embodiments of the present invention relate generally to providing real-time display of aspects of multiplayer games and tournaments via electronic devices connected to publicly viewable screens deployed at venues. Players may interact with the multiplayer games via mobile devices. The system may select views so that gameplay is only feasible for individuals physically located at the venue with a particular display device.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a system diagram of a multi-venue gaming and display system 100 having a plurality of venues with deployed content output devices according to a preferred embodiment of the present invention;

FIG. 2 is a sequence diagram of a process of the system of FIG. 1 for venue and tournament selection using a mobile device application; according to a preferred embodiment of the present invention;

FIG. 3 is an illustration of mobile devices at a venue 120A, according to a preferred embodiment of the present invention;

FIG. 4 is an illustration of mobile devices at a venue 120B, according to a preferred embodiment of the present invention; and

FIGS. 5-15 are example screenshots for creation of a tournament according to a preferred embodiment of the present invention.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates to providing real-time display of aspects of multiplayer games via electronic devices connected to publicly viewable screens deployed at venues.

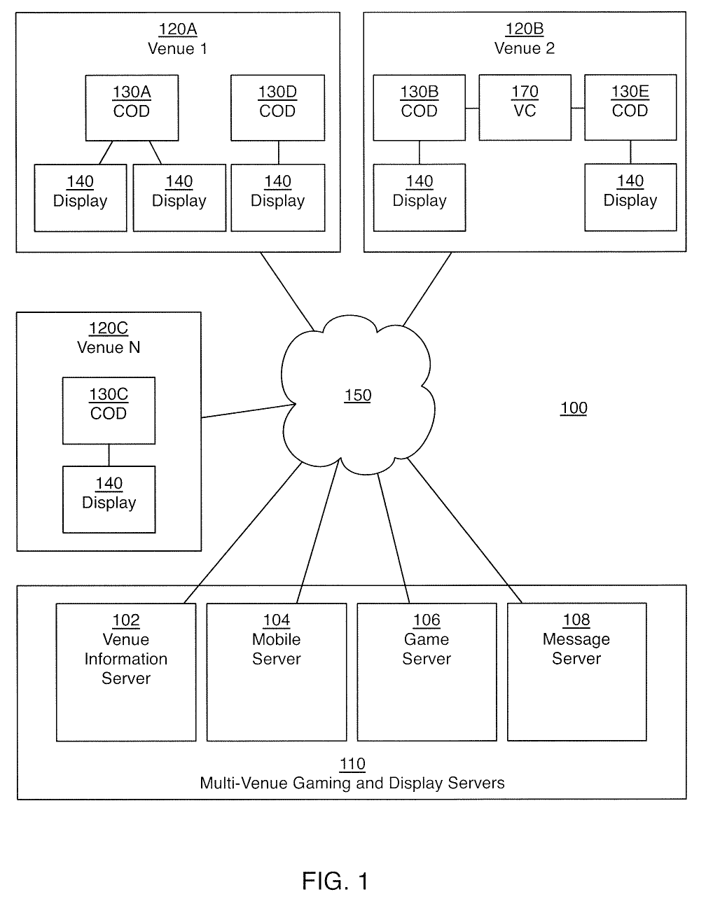

Referring to the drawings in detail, wherein like reference numerals indicate like elements throughout, FIG. 1 is a system diagram of a multiplayer gaming and display system 100 according to a preferred embodiment of the present invention. Servers 110 are connected by a network 150 to content output devices (CODs) 130A, 130B, 130C, and 130D, deployed at a plurality of venues 120A, 120B, 120C. The network 150 is preferably a wide area network, such as the Internet.

Servers 110 may be provided in a variety of configurations. For purposes of discussion, functions are described with respect to separate servers for particular functions. However, it is to be understood that these functions may be combined or separated as needed for a particular implementation within the scope of the invention. In a preferred embodiment, one or more venue information servers 102 may receive, store, and provide information regarding locations of mobile devices and content output devices 130. One or more mobile servers 104 may provide various services to mobile devices connecting to the multi-venue gaming and display system 100. One or more game servers 106 may provide functions related to one or more multiplayer games. For instance, one game server 106 may be allocated for operation of poker games while another may operate trivia games. One or more messaging servers 108 may provide message translation and/or load balancing functions.

The venue information servers 102, mobile servers 104, game servers 106, and message servers 108 may be implemented by any combination of computing devices, including one or more physical or virtual servers. The servers preferably implement an N-tier server infrastructure having one or more application servers, one or more web servers, one or more database servers, or the like. The servers may connect to each other through a local area network, not shown, or, in some cases, via network 150. The servers 110, as well as the CODs 130, may be implemented using purpose-built or general purpose computing hardware comprising processors for execution of program code for performing the processes described below, memory for storing program code and data, and interfaces for communications. Furthermore, any of the servers may utilize separate database servers for storage and retrieval of data, as well as other specialized servers or devices for other functions.

Each venue 120 preferably has a plurality of CODs 130 that output content to one or more communicatively coupled display devices 140. Each COD 130 may be any device capable of receiving and/or reading multimedia content, and outputting the multimedia content to a display device 140. For example, the CODs 130 may be digital receivers, computer devices, multimedia streaming devices such as APPLETV and BOXEE BOX, cable television set-top boxes, satellite television receivers, TIVO, SLINGBOX, and the like. In a preferred embodiment, each COD 130 is a small computer running a variant of the Linux operating system and additional software. The display devices 140 may be any electronic devices capable of outputting multimedia content to one or more patrons of the venue, such as televisions, projectors, monitors, and the like. In the preferred embodiment, there is no limit to the number of CODs 130 and display devices 140 that may be deployed at any particular venue. Furthermore, each COD 130 may output to more than one display device 140. In some embodiments, a COD 130 and display 140 may be combined in a single unit.

In the exemplary embodiment of FIG. 1, the first venue 120A includes two CODs 130A and 130D. The first COD 130A is connected to two different display devices 140. The second COD 130D is connected to only a single display device 140. In the same example, the second venue 120B includes two CODs 130B and 130E, each connected to a single display device 140. A plurality of other venues 120C also include various combinations of CODs 130 and display devices 140.

If there are multiple CODs at one address, they will preferably display the same content. In the event that the CODs at a particular venue are running different versions of software, associations will preferably be made such that the player connects with games on a server with which the COD with the newer version of software is communicating. In some embodiments, subsets of CODs in a venue may be used to allow display of views of multiple games at a time, or display of advertising simultaneously with one or more games.

CODs 130A, 130B, 130C, and 130D, are registered with the venue information server 102. The venue information server 102 may receive a registration request associated with a COD. The registration request may be a manual request to create a record for a new venue 120, or a dynamic request, such as a request transmitted by a newly-deployed venue controller 170 or COD 130. The request preferably includes information identifying the name and geographic location of the venue, and any other information necessary to register the venue, such as login and password information. The venue information server system 102 creates and/or updates database entries associated with the venue in a venue information database.

Registration of the CODs may be performed in a variety of ways. In one embodiment, a unique identifier of the COD may be associated with an address at which the COD is being installed. In a preferred embodiment, a serial number and MAC address are visible on the exterior of the COD. When a venue receives the COD, the installer may contact technical support by telephonic or electronic means and provide the serial number and MAC address for use in registration of the COD, along with a physical address and other identifying information regarding the venue. Registered addresses may then be provided to mobile device applications, as described below, facilitating, among other functions, association of a patron's mobile device with a venue.

At least some of the venues, such as 120B, may also have a venue controller 170 that is communicatively coupled to each of the CODs 130 deployed at the venue 120 by a local network, not shown. The venue controller 170 preferably provides a centralized graphical user interface, not shown, for controlling the plurality of CODs 130 deployed at the venue. The venue controller 170 may allow venue personnel to change the content output settings (e.g., channel change, volume change, audio source change, and the like) for one or more CODs 130 deployed at the venue 120. In one preferred embodiment, the venue controller 170 is the TAP.tv controller from AMI ENTERTAINMENT NETWORK.

The venue controller 170 may serve as the intermediary between the CODs 130 deployed at the venue 120 and the venue information server system 102 by aggregating data from the CODs 130 deployed at the venue 120 over a local network, not shown. The venue controller 170 may transmit the aggregated data over the network 150 to the venue information server system 102. It should be understood that not all venues 120 must have a venue controller 170. CODs 130 deployed at venues 120 that do not have a deployed venue controller 170 may individually communicate with servers 110 over the network 150.

The venue information server system 102 preferably includes a venue information database storing entries for each of a plurality of registered venues 120. The venue information database may store information identifying the CODs 130 deployed at each of the registered venues 120, for example, by a serial number, MAC address, or the like. Optionally, the venue information database also stores information identifying the display devices 140 deployed at each of the registered venues 120.

Interaction between players and tournament games is preferably facilitated by a mobile device application. The mobile device application may comprise, for instance, program code and data to facilitate connection to game servers, acceptance of game input, and rendering of game state, for a variety of games. In preferred embodiments, the mobile device applications are applications for the Apple iOS, Google Android, Windows Mobile, and other operating systems, and are made available for free download or purchase to users of those systems.

In some embodiments, upon launch, the mobile device application may first consult a specified URL or other identified location for information regarding an address of a mobile server 104 or other server of servers 110 to be contacted. The application may then make a services request to the specified server. The services request will preferably be accompanied by an authentication token known only to authorized mobile device applications. In some embodiments, the application may also be directed to a specific messaging server 108.

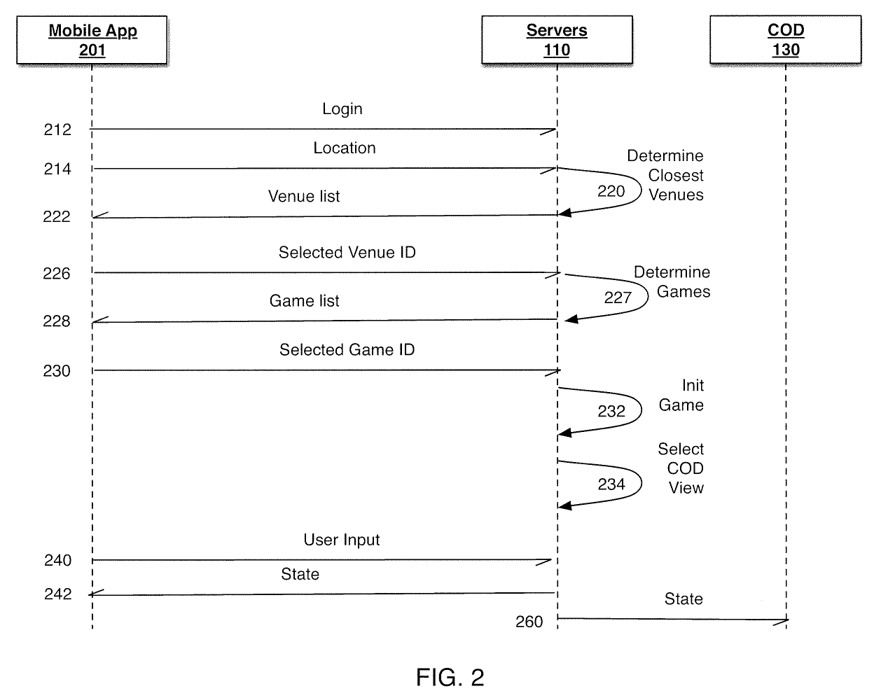

FIG. 2 is a sequence diagram of a process of the system of FIG. 1 for venue and tournament selection using a mobile device application. The present example assumes that the mobile device application has, or has already obtained, an address for a server associated with the system 100. In some embodiments, the mobile application will connect at launch to an external website, not shown, always available to request the addresses of a mobile server 104 and messaging server 108 to be used. A successful request will preferably require use of a token, which may be hardcoded in the binary of the mobile device application.

At 212, the mobile device application 201 performs a login process with one or more servers of servers 110. In a preferred embodiment, a username and password are used in the login process. The user name and password may be entered by the user or submitted from previously stored information by the application 201. The login process may involve additional steps, not shown, including multiple rounds of communication back and forth between the mobile device application and one or more servers. In a preferred embodiment, communication between the mobile device application and the server is encrypted, preferably using HTTPS.

Upon successful login, the mobile device application 201 preferably obtains location information from the mobile device operating system, if allowed. If location information is not available to the mobile device application, the user may be prompted by the mobile device application to make changes to mobile device settings to allow such access.

Once information regarding the location of the device has been obtained, a registration message 214 is sent to a server 110 associated with the multiplayer gaming system 100. In a preferred embodiment, latitude and longitude data are sent to the server. The server may then determine at 220 which venues are closest to the mobile device location, or within a particular radius, such as 30 miles.

Data regarding nearest venues, or alternatively, regarding the CODs 130 at the venues, is then returned to the mobile app at 222. The data preferably comprises names, locations, and identifiers of the venues. In a preferred embodiment, those venues are then presented by mobile device application 201 to the user in order of distance, from closest to furthest. In a preferred embodiment, the mobile device application 201 sends an HTTP GET to the mobile server 104 with an ID, and receives a JSON object with list of CODs and a list of channels or games.

The user may then select the actual venue at which he or she is present from the presented list. At 226, the mobile device application 201 sends an indication of the selected venue, preferably an ID, back to server 110.

In another embodiment, the accuracy of the location data provided in the registration message may be deemed accurate enough, or the spacing of venues may be large enough, to facilitate automatic selection of the venue in which the device appears to be located. In such a case, the venue appearing to be at the smallest distance from the mobile device may be automatically selected without the return of a list at 222 or response with a selection at 226.

Once a venue has been selected at 226, the server 110, at 227, determines a list of available games associated with the selected venue and sends the mobile device application a list of available games, such as trivia, poker, racing, or the like, at 228. The player selects one of the games, causing the mobile device application to contact the server for that game at 230. It is to be understood that while “games” are described for purposes of discussion, the list may comprise other applications with social interaction.

At 232, the game is initialized or the player is joined with an already in-progress game. If the player is the first player at the venue to join a game, the server may then select a new view to be presented on a COD 130 at the player's location at 234.

Following initiation of the user's participation in the game, generally, user inputs will be sent to the servers 110 at 240 and game state information will be sent to the mobile device application 201 at 242 and to the COD 130 at 260, if the COD 130 is displaying aspects of the relevant game. As will be understood by those skilled in the art, 240, 242, and 260 may occur repeatedly and in any order during the progress of a game.

As described above, while reference is made to a game server, the actual implementation may use one or more physical or virtual servers along with load balancers, database servers, routers and other equipment. The term “game server” as used herein refers to the collective function of these components. In a preferred embodiment, each type of game is implemented using a separate game server or cluster.

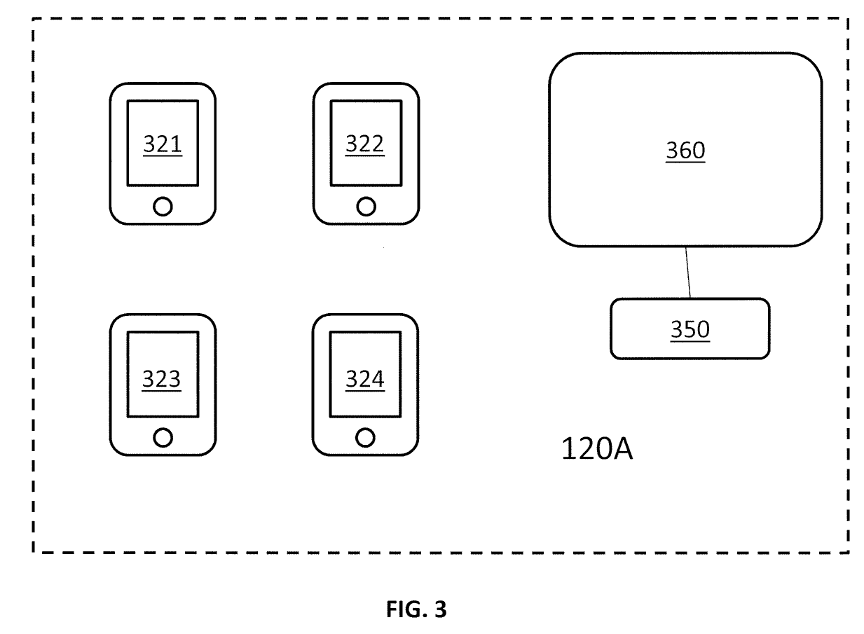

FIG. 3 is an illustration of the physical devices at a venue 120A in the example tournament game of trivia. Mobile devices 321, 322, 323, and 324 represent devices of human players present at venue 120A. One or more CODs 130A is connected to one or more displays 140 at venue 120A. Each mobile device 321, 322, 323, and 324 will be in communication with the servers 110. In a preferred embodiment, trivia questions, as well as the multiple choice answers, will be presented on one or more CODs 130A and displays 140 at the venue 120A. Players may select answers to trivia questions via their mobile devices 321, 322, 323, 324 at the venue 120A.

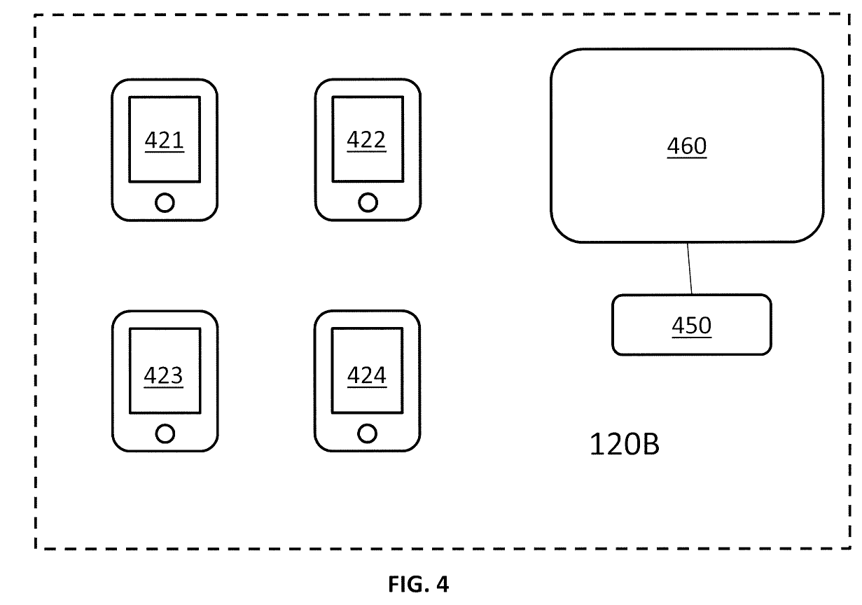

The system is preferably designed so that players physically located at different venues, that are not scheduled to participate in a designated tournament, cannot feasibly compete in the designated tournament. For example, as shown in FIG. 4, mobile devices 421, 422, 423, and 424 represent devices of human players present at venue 120B. One or more CODs 130B is connected to one or more displays 140 at venue 120B. An individual located at venue 120B (e.g., using mobile device 421), but not scheduled to participate in the tournament, may attempt to participate in the tournament and incorrectly select (e.g., from a location selection screen of the system) that he is located at venue 120A.

The system effectively scrambles the displayed order of possible answers in a manner specific to the particular venue. As such, even though question #1 at venue 120A may be the same as question #1 at venue 120B, the correct multiple choice designation (e.g., A, B, C, or D) may be different. In other words, the correct answer to question #1 at venue 120A may correspond to multiple choice designation “A”. On the other hand, the correct answer to question #1 at venue 120B may correspond to multiple choice designation “B”. Because the displayed order of possible answers is specific to the venue, only those correctly scheduled players viewing the displays (e.g., 140) in venue 120A will have a feasible chance to compete in the tournament running in venue 120A. Conversely, only those correctly scheduled players viewing the displays 140 in venue 120B will have a feasible chance to compete in the tournament running in venue 120B.

For example, a question of the tournament may be “Who was the 2015 coach of the Philadelphia Eagles?” The correct answer “Chip Kelly” may be answer choice “A” at venue 120A, and answer choice “B” at venue 120B. As such, an individual at venue 120B could not pretend to be in venue 120A, by selecting (or purporting) to be at venue 120A, and expect to perform well enough to feasibly compete with others correctly registered at venue 120A. Occasionally, such an individual may luckily still select the right answer, but not for numerous questions, and not over multiple games. Therefore, generally, the system's scrambling of answer choices serves to ensure a player of a tournament is participating at a location at which they actually are scheduled to be participate and are physically located.

Other aspects of tournament play are further described in connection with mobile application screenshots attached hereto as Appendix A, TOURNAMENT CREATION.

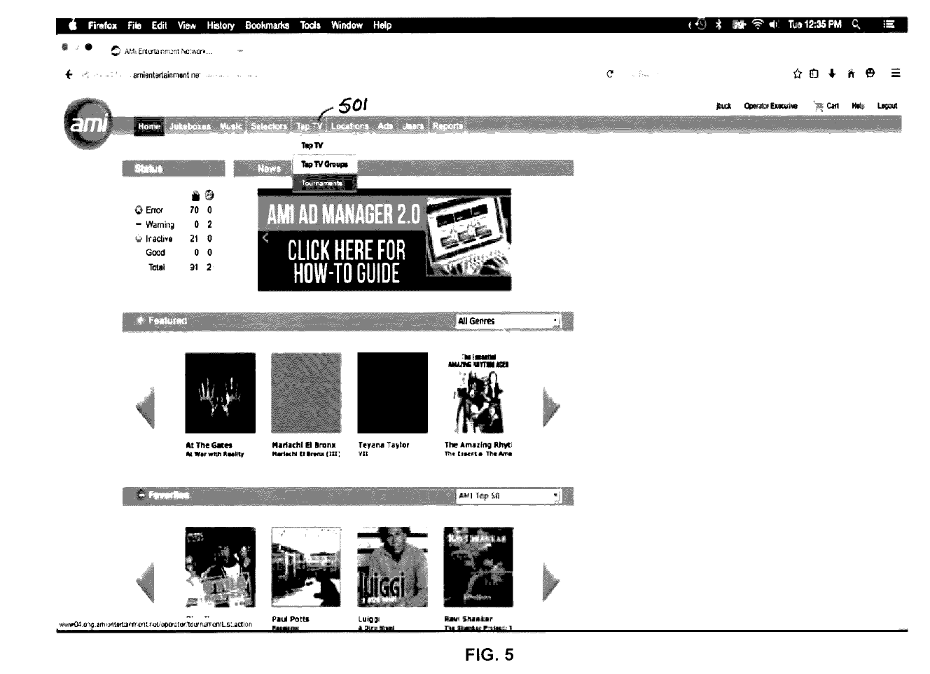

Referring now to FIGS. 5-15, embodiments of the present invention include a tournament creation tool for creating tournaments which may include one or more electronic games. Such tournaments may be created by an operator or other associated personnel. Generally, a tournament includes a plurality of tournament games playable by a plurality of players. Each tournament game generates a total player score upon completion of play. The player scores are used to determine tournament winners.

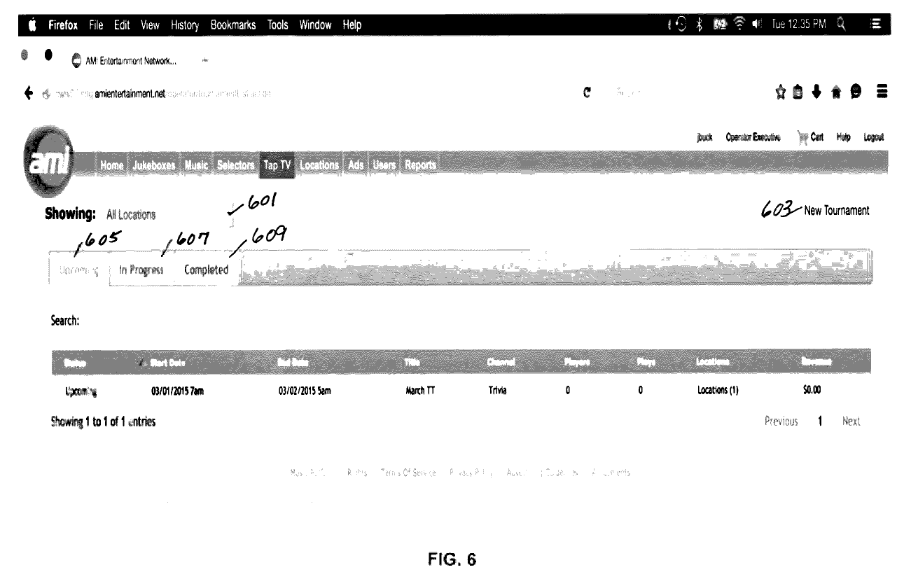

Referring now to the screenshot in FIG. 5, the tournament creation tool may be available on an operator website under a Tap TV tab 501. Upon selecting tournaments under the Tap TV tab 501, the operator is presented with a tournament home page, an example screenshot of which is shown in FIG. 6. The tournament home page allows the operator to view previously scheduled tournaments (via drop down menu 601) and/or to create a new tournament via new tournament button 603. As shown, the default view is all locations, e.g., the tool will display all locations having a tournament. However, the drop down menu 601 can be used to filter the view to group specific or location specific tournaments.

The home page also includes various tabs including but not limited to an Upcoming tab 605, an In Progress tab 607, and a Completed tab 609. Upon selecting the Upcoming tab 605, as shown in the example screen shot in FIG. 6, the tool displays a list of tournaments that have already been scheduled but have not started. More specifically, this list provides tournament information of future tournaments, such as start and end dates, tournament names, game channel, players, plays and revenue potentially generated from play of the tournament. Upon clicking on a tournament name, further details of the tournament can be provided. It should be noted that upcoming tournaments are still capable of being edited.

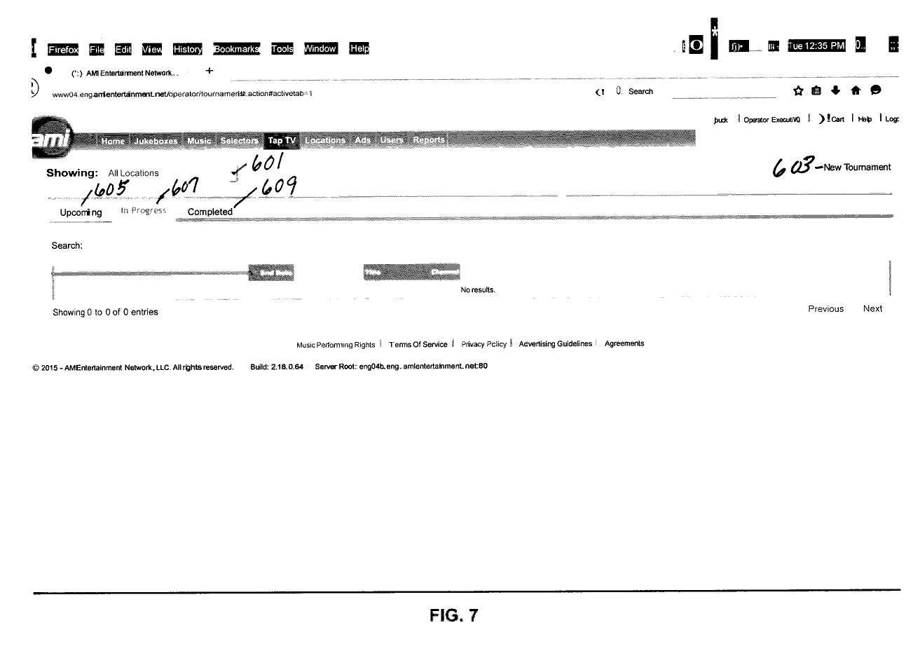

Upon selecting the In Progress tab 607, the tool displays a list of tournaments that are currently running, an example screenshot of which is shown in FIG. 7. This list also provides tournament information similar to that of the upcoming tournament status information, but also including current leaderboards. Upon clicking on a tournament name, further details of the tournament can be provided. As shown in the example screenshot of FIG. 7, there are currently no tournaments in progress.

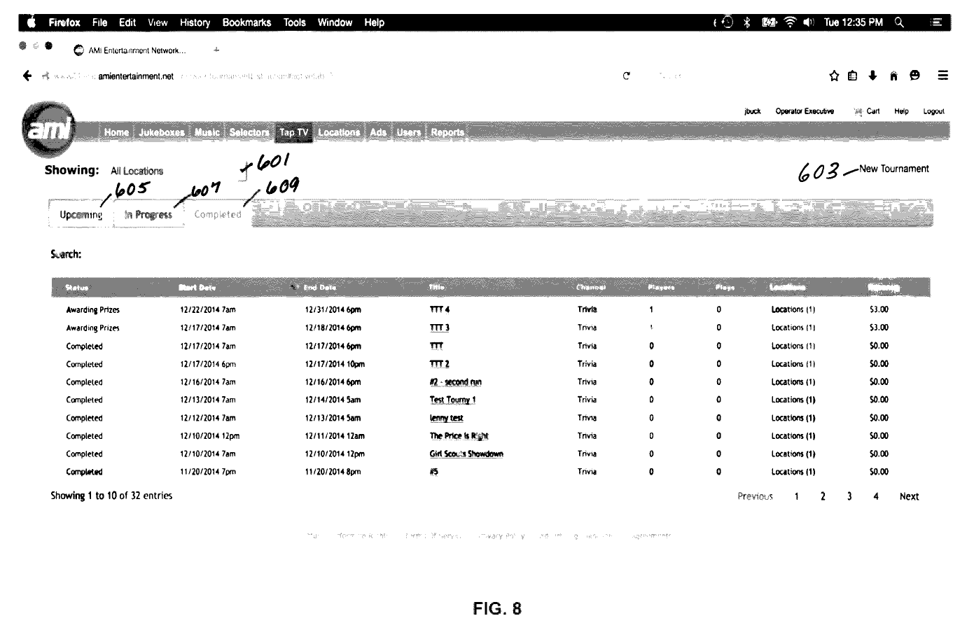

Upon selecting the Completed tab 609, the tool displays a list of tournaments that have ended, an example screenshot of which is shown in FIG. 8. This list also provides tournament information similar to that of the upcoming tournament information, but also including final leaderboards that may identify high scoring players. By clicking on a tournament name, further details of the tournament can be provided.

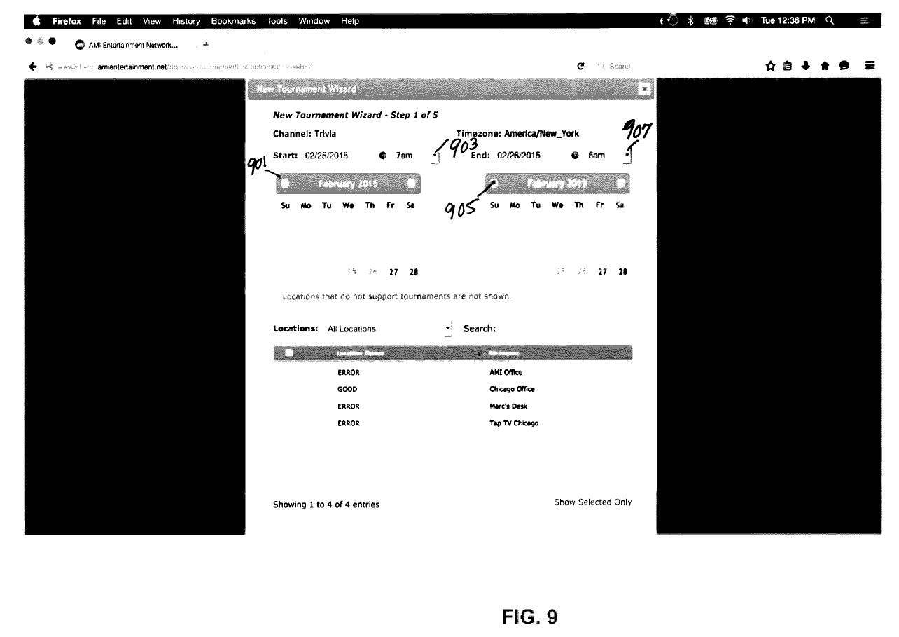

The operator can create a new tournament by clicking the new tournament creation button 603. Upon selecting the new tournament creation button 603, the operator is presented with a setup screen as shown in FIG. 9. From this screen, the operator can select start and end times for the tournament. The start time can be selected via calendar 901 and drop down menu 903. Similarly, the end time of the tournament can be selected via calendar 905 and drop down menu 907.

Each tournament can run in one or multiple locations. In a status window 909, location names are displayed along with the status of installed COD(s). For example, location status can be described as “good”, “bad” or “error”, or “mixed”. A good status refers to a location with at least one COD that appears to be working properly. Alternatively, a bad (error) status refers to a location that does not have at least one unit that appears to be working properly. A mixed status refers to a location where multiple CODs are installed with some working properly and others not working properly.

The operator can select one or more locations that will participate in the tournament through drop down menu 911, and/or selecting a box 913 adjacent to a desired location. The drop down menu 911 may include a list of locations capable of hosting the tournament to be created. Alternatively, the operator may enter a desired location for the tournament via field 915.

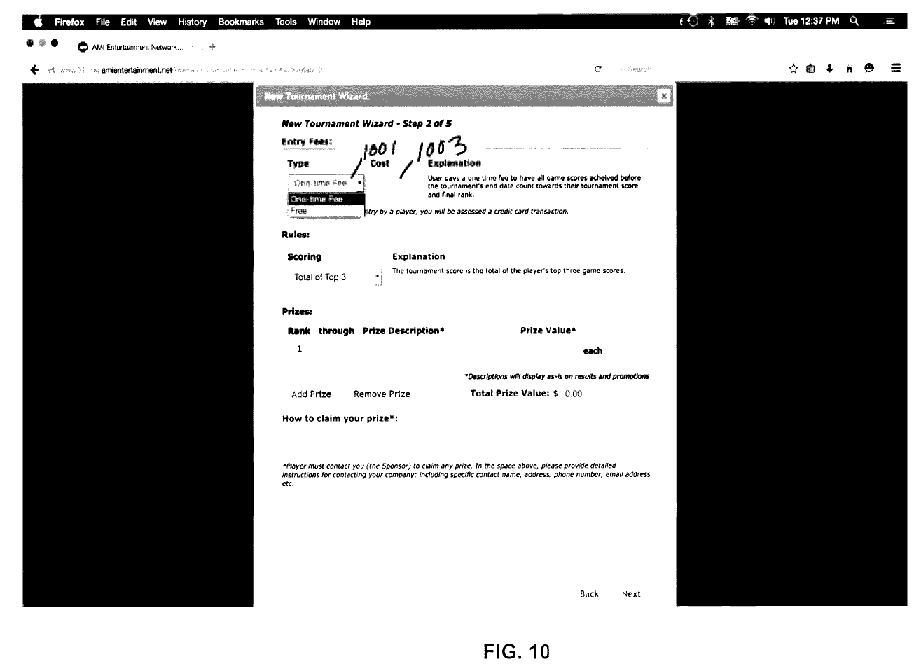

Referring now to an example screenshot in FIG. 10, the tournament creation tool allows the operator to set entry fee options for participation in the tournament, via a drop down menu 1001. The fee options include but are not limited to: free (i.e., no fee), a one-time fee, and a daily buy-in. A free tournament has no fee to join. As such, an interested player need only choose to participate. The one-time fee refers to a fee that must be paid if the player wishes to join the tournament. The player will not incur any subsequent fees to participate in the tournament. The daily buy-in fee refers to a fee that must be paid each new day that the player wishes to participate (e.g., to improve his or her score). Once paid, all scores achieved before a predetermined time (e.g., 5 am the following day or before the close of business of the location) will be recorded for the tournament. In an effort to improve his or her score and rank, a player will be required to pay another daily buy-in fee to participate in each subsequent day the tournament is scheduled to run. As such, the daily buy-in fee is only an available option for tournaments that span multiple days. In tournaments that the operator requires a fee (e.g., one-time fee or daily buy-in), the operator has the ability to set the fee price by entering a desired fee value in field 1003.

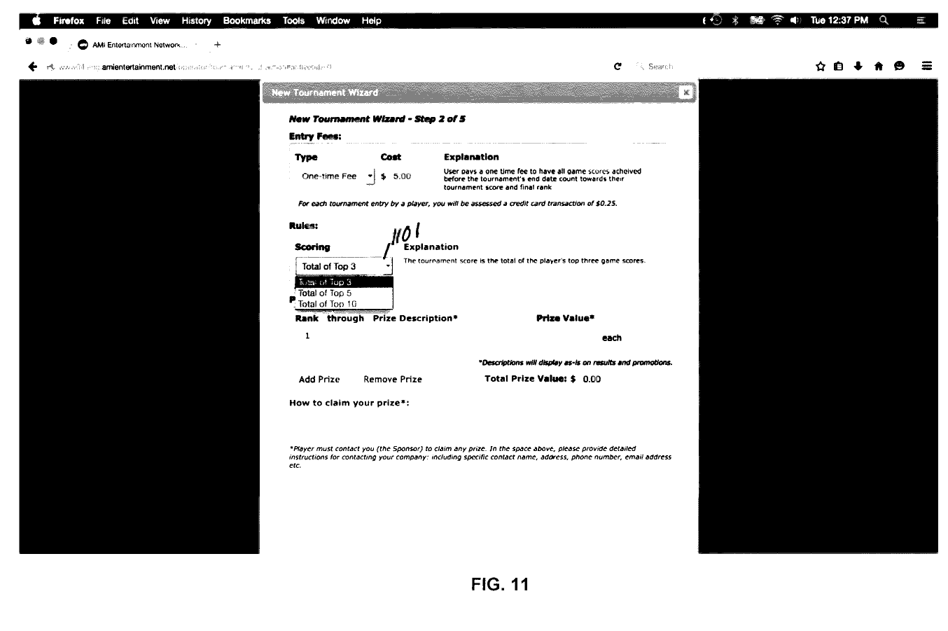

Each tournament may include one or more rounds of play. Each tournament generates a total player score upon completion of play. The player scores are used to determine tournament winners. As shown in an example screenshot in FIG. 11, the tournament creation tool allows the operator to set how the total scores are tabulated via a drop down menu 1101. For example, the total score may be calculated based on a player's top 3 scores, top 5 scores, or top 10 scores. Other total score options are also contemplated in keeping with the invention.

The system may modify setting options available to the operator based on previous operator selections. For example, in the event the operator has set the tournament to run for only one hour, the tool may only allow calculation of the top 3 scores to determine winners. Such a restriction may be employed because, in certain games, one hour is not enough time for more than 3 rounds of play by any one player. Accordingly, the system may only make the top 5 total scoring option available for tournaments that span at least 2 hours; and the top 10 total scoring option available for tournaments that span at least 4 hours.

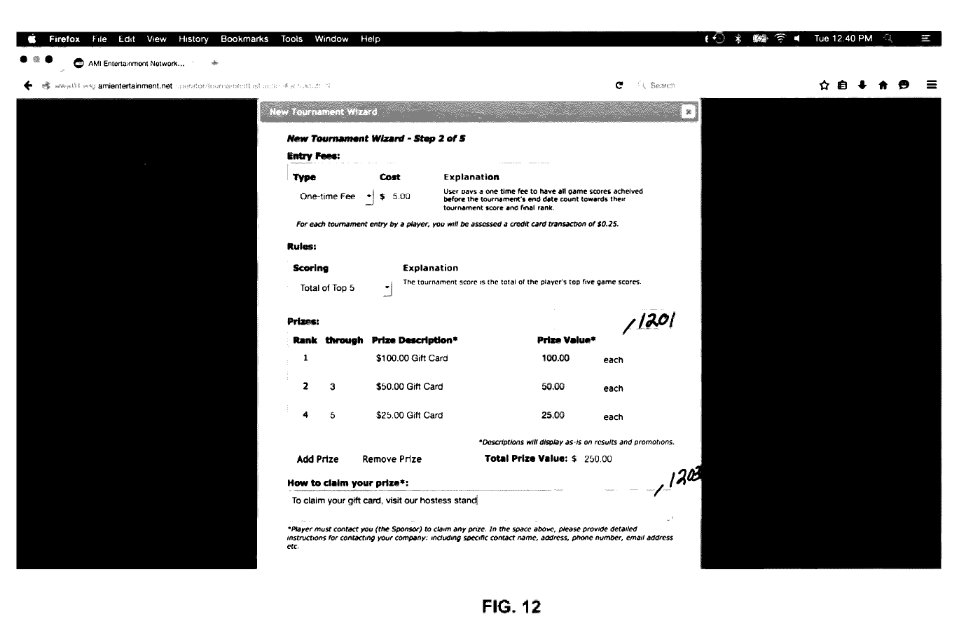

FIG. 12 is an example screenshot of a setup page allowing the operator to select prize options for certain players of the tournament. A prize option area 1201 allows the operator to award a prize to a single winner (e.g., with the highest total score or rank of the tournament), or to multiple players (e.g., the players having the top 5 total scores of the tournament). The type of prizes may also be set by the operator. As shown in FIG. 12, the operator has chosen to award the highest ranked player with a $100.00 gift card, the each of the next two highest ranked players (ranks 2 and 3) with a $50.00 gift card, and each of the players ranked 4 and 5 with $25.00 gift cards. It is noted that these prize details may be displayed on display screens within the venue for which the tournament is being run. In a prize notes field 1203, the operator may enter instructions for a player to claim his or her prize.

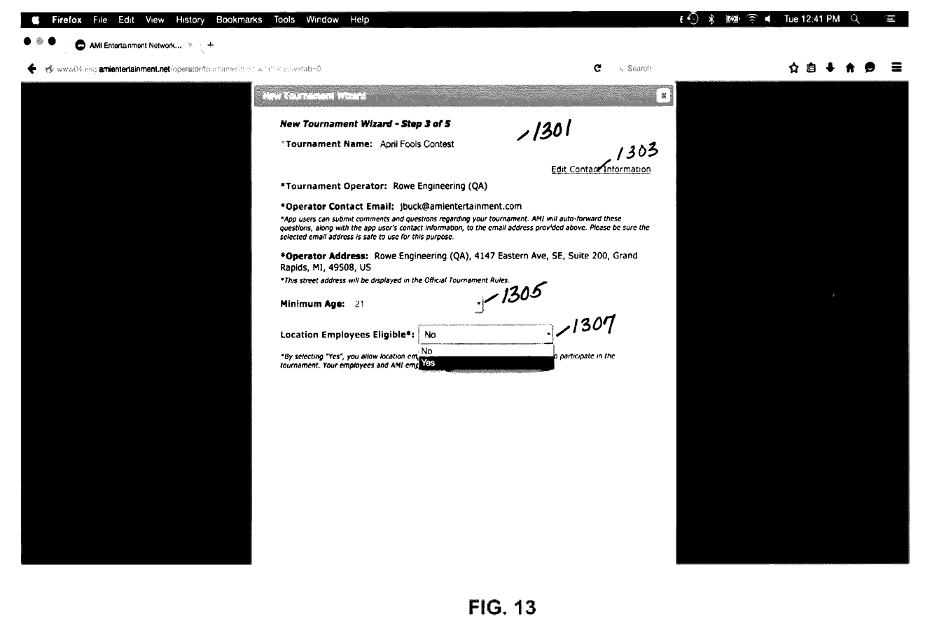

FIG. 13 is a screenshot showing other details the operator may enter regarding the tournament. For example, as shown, the operator may input a tournament name in field 1301. The operator may also enter, and edit his or her contact information (by clicking an edit link 1303), which may include but is not limited to the operator's name, email, and address. The operator can enter a minimum age for participation in the tournament via a drop down menu 1305. Also, the operator has the ability to allow or not allow employees of a particular location where the tournament is being run the ability to participate in the tournament, through a drop down menu 1307.

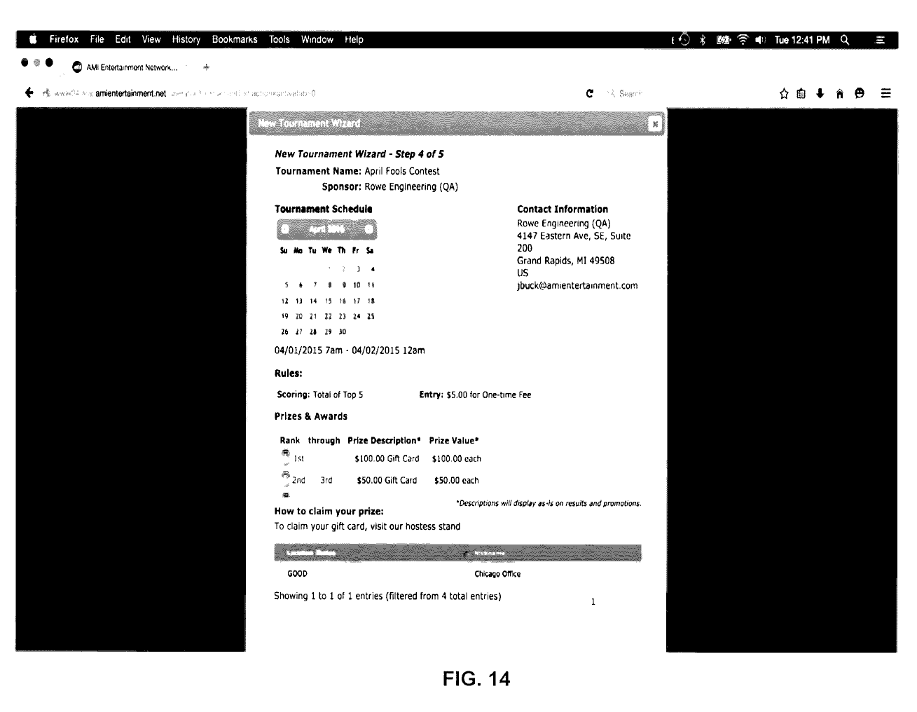

Upon completion of setting up the tournament, the operator is presented with a screen showing a consolidated view of his or her selections and other information regarding the tournament settings. An example of such a screen is shown in FIG. 14.

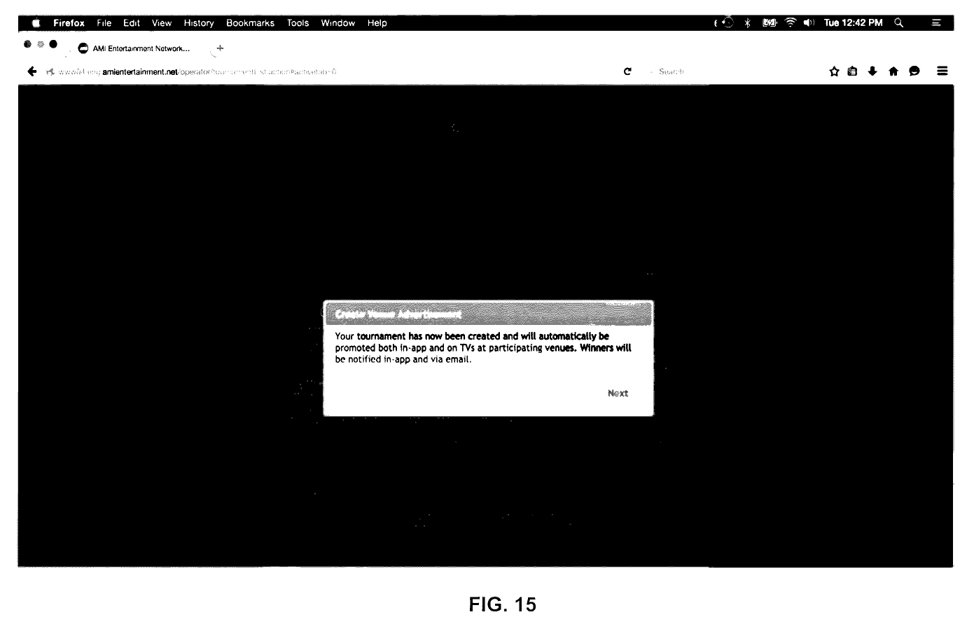

FIG. 15 is a screenshot showing the operator how the official tournament rules will be displayed to players of the tournament. These official tournament rules serve as the agreement between the operator and the player(s). These rules may be automatically generated based upon information provided during the tournament creation process.

To ensure complete creation of a tournament for game play, one or more error messages may be displayed to the operator if he or she attempts to advance to a next step in the tournament creation process, or otherwise complete the creation of the tournament, without sufficiently configuring one or more aspects of the tournament. Such error may include but are not limited to the following:
Please complete the required fields.
Please remove locations with tournaments already scheduled during your selected dates.
Please select a location to participate in the tournament.
Dates must be formatted as MM/DD/YYYY. Time must be formatted as HH:MM.
Prize rank is invalid. Please enter whole numbers only.
Prize value is invalid. Please enter a dollar value.
Tournament Fee entered is invalid. Please enter a dollar value.
Please enter a dollar value for the tournament fee.
Tournament requires at least one prize.
A valid email address is required to manage questions from participants.
Please select an end date and time that occurs after the start date and time.
A new tournament cannot be started until 7 am EST tomorrow. Please choose a different start date.

The display (e.g., on a trivia channel on a display in the venue or mobile device) however, may also occasionally display advertising content during ad breaks. Ad breaks may be scheduled to occur during breaks (e.g., mid-game breaks) within a tournament currently being run, or after a tournament has completed (“e.g., post-game breaks). During mid-game breaks, types of ads to be displayed include but are not limited to the following:
Ad Manager
Back in X Time
Game Promo
Future Tournament
Bookend
   During post-game breaks, types of ads to be displayed include but are not limited to the following:
Up Next
Player of the Hour
Ad Manager
Tournament
Common Feature
Highlighted Feature
Bookend

The “Ad Manager” type renders control of the system to an external entity (e.g., employees of the venue location), to display promotions or other advertisements specific to the venue (e.g., menu specials, venue hours, and the like). The Ad Manager preferably runs for a duration of 60 seconds during mid-game ad breaks. The Ad Manager preferably runs for a duration of 90 seconds during post-game ad breaks.

The “Back in X Time” type identifies the tournament game currently being played and specifies a time that the tournament game will resume. For example, during the mid-game break, this type of ad break may state, on a display, that the tournament game will resume in 1 minute.

The “Common Features” type promotes general features of products. Such promotions include instructions on viewing a trivia schedule, accessing the trivia report card, changing an initial answer before time expires, and other instructions on tournament gameplay.

The “Game Promo” type of ads are shown when other types of ad types may not be available. This ad type may promote different trivia tournament games available, for example, on Tap TV.

The “Future Tournaments” type of ads promote created tournaments that have not started yet. These “future” tournaments can be promoted, preferably, up to 20 days in advance of their start date. If there is no future tournament to be promoted, a Common Feature type ad can be displayed.

The “Book End” type ad is an animated, preferably orange-colored ad displayed the system (Tap TV) logo. Such an ad type is used as a wrap-up to each ad break before gameplay resumes.

The “Up Next” type of ad displays the next scheduled tournament to be played.

The “Player of the Hour” type shows the top players of the hour, preferably up to the top 5 players, for the last complete hour. For example, if an ad of this type is shown in an ad break after a 10:00 or 10:20 game, this top player information reflects the top players from the 9:00 hour (e.g., the last completed full hour of gameplay). If this ad is shown in an ad break after a 10:40 game, the information shown is from the 10:00 game, since this hour's games are now complete. Alternatively, if no players participated within the last hour, a common feature type of ad is shown.

The “Tournament” type of ad includes a congratulatory display, a congratulatory list display, and a player prize list display. The congratulatory display states that a tournament has ended. The congratulatory list display shows tournament information about a tournament that has ended within the last 10 days, and shows winners and prizes of the top scoring players. The player prize list display may be displayed if another tournament in a venue is still running, and may display information regarding the same (e.g., top scoring players, prizes, and the like).

The “Highlighted Feature” type of ad shows national ranking information. For example, this ad type may show rankings of aggregated venue scores to give players an indication of the venue in which they participated ranks with other venues hosting similar tournaments.

The multiplayer games may use a variety of architectures, such as synchronous peer-to-peer or client-server. In a preferred embodiment, a client-server architecture is used. Game server 106 preferably processes user input from multiple clients, coordinates the game, and sends results to clients for rendering of the player views. Thus, while multiple game clients may be co-located at a venue with one or more CODs, in a preferred embodiment, those devices do not engage in any direct peer-to-peer communication regarding the game. Instead, each device communicates with game server 106.

In a preferred embodiment, game client and COD platforms may be heterogenous, either executing cross-platform game code or platform-specific game code designed to process a common network communication protocol. In a preferred embodiment, each client receives information from the server sufficient to render the “world” from a player's perspective.

In a preferred embodiment, information is passed from client to server and server to client via messages. In a preferred embodiment, the messages comprise a message name and a sequence of object name-data pairs. Messages may be text strings, preferably transmitted in a compressed and/or encrypted form. In a preferred embodiment, a colon separator is used between the message name and object list, each object name-data pair is enclosed by curly brackets, and data values of the object are delimited by vertical bars or carats.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for public presentation of a game at a venue, the method comprising:
determining whether one or more players is registered for the game at the venue;
in response to a determination that there are one or more players registered for the game at the venue:
transmitting venue specific game information regarding the game to one or more displays at the venue; and
simultaneously receiving one or more responses to the transmitted game information from one or more mobile devices associated with the one or more registered players respectively.

2. The method of claim 1, wherein the venue specific game information includes a trivia question of the game, and an arrangement of possible answers to the trivia question.

3. The method of claim 2, wherein one of the one or more responses includes an answer selection to the trivia question.
